(19) United States
(12) Patent Application Publication
(10) Pub. No.: US 2026/0023169 A1
(43) Pub. Date: Jan. 22, 2026

(54) METHOD AND SYSTEM FOR LEARNING SCENE RECONSTRUCTION FROM POLARIZED WAVEFRONTS

(71) Applicant: Torc Robotics, Inc., Blacksburg, VA (US)

(72) Inventors: Felix Heide, New York City, NY (US); Mario Bijelic, Frankfurt, Hesse (DE)

(21) Appl. No.: 18/780,078

(22) Filed: Jul. 22, 2024

(51) Int. Cl. G01S 7/499; G01S 7/481; G01S 7/4861; G01S 7/4865; G01S 17/931

(52) U.S. Cl. CPC G01S 7/499; G01S 7/4817; G01S 7/4861; G01S 7/4866; G01S 17/931

(57) ABSTRACT

The application generally relates to a polarimetric wavefront light detection and ranging (PolLidar) sensor. The PolLidar sensor includes an emitter module having an optical emitter aperture, a receiver module having an optical receiver aperture, and a mirror for scene scanning. The receiver module is separate from the emitter module.

### TECHNICAL FIELD

The field of the disclosure relates generally to autonomous vehicles and, more specifically, to systems and methods for learning scene reconstruction from polarized wavefronts.

### BACKGROUND

Autonomous vehicles employ fundamental technologies such as, perception, localization, behaviors and planning, and control. Perception technologies enable an autonomous vehicle to sense and process its environment. Perception technologies process a sensed environment to identify and classify objects, or groups of objects, in the environment, for example, pedestrians, vehicles, or debris. Localization technologies determine, based on the sensed environment, for example, where in the world, or on a map, the autonomous vehicle is. Localization technologies process features in the sensed environment to correlate, or register, those features to known features on a map. Localization technologies may rely on inertial navigation system (INS) data. Behaviors and planning technologies determine how to move through the sensed environment to reach a planned destination. Behaviors and planning technologies process data representing the sensed environment and localization or mapping data to plan maneuvers and routes to reach the planned destination for execution by a controller or a control module. Controller technologies use control theory to determine how to translate desired behaviors and trajectories into actions undertaken by the vehicle through its dynamic mechanical components. This includes steering, braking and acceleration.

Large-scale outdoor scene reconstruction is essential for advancing autonomous robotics, drones, and driver-assistance systems, serving as the foundation for scene understanding, safe navigation, dataset generation and validation. Light detection and ranging (LiDAR) sensor has become a cornerstone sensing modality for large outdoor scenarios and autonomous driving. Conventional LiDAR sensors are capable of providing centimeter-accurate distance information by emitting laser pulses into a scene and measuring the time-of-flight (ToF) of the reflection. However, the polarization of the received light that depends on the surface orientation and material properties is usually not considered.

This section is intended to introduce the reader to various aspects of art that may be related to various aspects of the present disclosure described or claimed below. This description is believed to be helpful in providing the reader with background information to facilitate a better understanding of the various aspects of the present disclosure. Accordingly, it should be understood that these statements are to be read in this light and not as admissions of prior art.

### SUMMARY

In one aspect, a polarimetric wavefront light detection and ranging (PolLidar) sensor including an emitter module having an optical emitter aperture, a receiver module having an optical receiver aperture, and a mirror for scene scanning is provided. The receiver module is separate from the emitter module.

In another aspect, a vehicle including at least one sensor, at least one memory storing instructions thereon, and at least one processor configured to execute the stored instruction is provided. The stored instructions, when executed by the at least one processor, cause the at least one processor to: (i) initiate emission of horizontally polarized laser light by the at least one sensor; (ii) cause reception of light reflected from an object at a detector of the at least one sensor; (iii) compute temporal polarimetric reflectance of a scene as a model that is a sum of a specular reflection and a diffuse reflection; (iv) compute a first Mueller matrix for an emitter module of the at least one sensor; (v) compute a second Mueller matrix for a receiver module of the at least sensor; (vi) generate synthetic polarimetric raw wavefronts based at least in part upon the computed first and second Mueller matrices and the computed temporal polarimetric reflectance of the scene; and (vii) generate temporal wavefronts from the generated synthetic polarimetric raw wavefronts to model beam divergence and scene reconstruction.

In yet another aspect, a computer-implemented method is provided. The computer-implemented method includes (i) initiating emission of horizontally polarized laser light by a polarimetric wavefront light detection and ranging (PolLidar) sensor, the PolLidar sensor including (a) an emitter module having an optical emitter aperture, (b) a receiver module having an optical receiver aperture, and (c) a mirror, wherein the receiver module is separate from the emitter module; (ii) causing reception of light reflected from an object at a detector of the PolLidar sensor; (iii) computing temporal polarimetric reflectance of a scene as a model that is a sum of a specular reflection and a diffuse reflection; (iv) computing a first Mueller matrix for the emitter module; (v) computing a second Mueller matrix for the receiver module; (vi) generating synthetic polarimetric raw wavefronts based at least in part upon the computed first and second Mueller matrices and the computed temporal polarimetric reflectance of the scene; and (vii) generating temporal wavefronts from the generated synthetic polarimetric raw wavefronts to model beam divergence and scene reconstruction.

Various refinements exist of the features noted in relation to the above-mentioned aspects. Further features may also be incorporated in the above-mentioned aspects as well. These refinements and additional features may exist individually or in any combination. For instance, various features discussed below in relation to any of the illustrated examples may be incorporated into any of the above-described aspects, alone or in any combination.

### BRIEF DESCRIPTION OF DRAWINGS

The patent or application file contains at least one drawing executed in color. Copies of this patent or patent application publication with color drawings will be provided by the Office upon request and payment of the necessary fee.

The following drawings form part of the present specification and are included to further demonstrate certain aspects of the present disclosure. The disclosure may be better understood by reference to one or more of these drawings in combination with the detailed description of specific embodiments presented herein.

FIG. 1 is a schematic view of an autonomous truck;

FIG. 2 is a block diagram of the autonomous truck shown in FIG. 1;

FIG. 3 is a block diagram of an example computing system;

FIG. 4 is an illustration of an example PolLiDAR sensing and scene reconstruction;

FIG. 5 is an illustration of an example PolLiDAR dataset;

FIG. 6 is an illustration of an example PolLidar forward model and simulator;

FIG. 7 is an illustration of an example neural polarization wavefront LiDAR reconstruction;

FIG. 8 is an example table showing quantitative evaluation for normal on synthetic data;

FIG. 9 is an illustration of example qualitative evaluation on synthetic data;

FIG. 10 is an example illustration of qualitative evaluation on experimental data;

FIG. 11 is an example table showing quantitative evaluation for normal on experimental data;

FIG. 12 is an example table showing results of ablation experiments for different modules on synthetic data; and

FIG. 13 is a flow-chart of method operations for learning scene reconstruction from polarized wavefronts, as described herein according to some embodiments.

Corresponding reference characters indicate corresponding parts throughout the several views of the drawings. Although specific features of various examples may be shown in some drawings and not in others, this is for convenience only. Any feature of any drawing may be referenced or claimed in combination with any feature of any other drawing.

### DETAILED DESCRIPTION

The following detailed description and examples set forth preferred materials, components, and procedures used in accordance with the present disclosure. This description and these examples, however, are provided by way of illustration only, and nothing therein shall be deemed to be a limitation upon the overall scope of the present disclosure. The following terms are used in the present disclosure as defined below.

An autonomous vehicle: An autonomous vehicle is a vehicle that is able to operate itself to perform various operations such as controlling or regulating acceleration, braking, steering wheel positioning, and so on, without any human intervention. An autonomous vehicle has an autonomy level of level-4 or level-5 recognized by National Highway Traffic Safety Administration (NHTSA).

A semi-autonomous vehicle: A semi-autonomous vehicle is a vehicle that is able to perform some of the driving related operations such as keeping the vehicle in lane and/or parking the vehicle without human intervention. A semi-autonomous vehicle has an autonomy level of level-1, level-2, or level-3 recognized by NHTSA.

A non-autonomous vehicle: A non-autonomous vehicle is a vehicle that is neither an autonomous vehicle nor a semi-autonomous vehicle. A non-autonomous vehicle has an autonomy level of level-0 recognized by NHTSA.

Various embodiments described herein correspond with systems and methods for scene reconstruction using a long-range polarization wave-from LiDAR sensor (PolLidar) that modulates the polarization of the emitted and received light. In contrast to the conventional LiDAR sensors, PolLidar allows access to the raw time-resolved polarimetric wavefront using a learned reconstruction method. The learned reconstruction method jointly estimates normals, distance and material properties from the raw measurements. The learned reconstruction method is trained and evaluated using a simulated and real-world long-range dataset with paired raw lidar data, ground truth distance and normal maps. By way of a non-limiting example, the learned reconstruction method improves normal and distance reconstruction by up to about 53% mean angular error and up to above 41% mean absolute error compared to existing shape-form-polarization (SfP) and ToF methods.

Sensing and reconstructing large scenes is crucial for safety-critical applications in autonomous driving, drones, remote sensing, scene understanding and dataset generation for 3-dimensional (3D) vision. Scanning LiDAR sensors have been broadly adopted as a cornerstone sending modality that provides precise range information. Generally, these LiDAR sensors operate by measuring the time-of-flight of laser pulses emitted into and returned from the scene. The emitted light is typically polarized and the polarization changes upon reflection depending on surface normal and material properties. While the off-the-shelf LiDAR sensors detect intensity and, as such, ignore the additional polarization information, the methods described in the present disclosure may be used to reconstruct large automotive scenes, for example, up to about 100 meters range, using geometric and material information in the polarized state, which otherwise is ignored or abandoned.

Polarization and its benefits are generally unexplored in the context of LiDAR sensing in vision and robotics. While polarization information of camera images may be used for shape estimation, stereo depth estimation, depth completion, and dehazing, but because the polarization information is collected using passive sensors, the collected polarization information is ineffective generally at nighttime. Currently known polarization information collecting methods using active polarimetric ToF systems for scene reconstructions are also limited for use with indoor scenes with object-level contents and prohibiting the measurement of large outdoor scenes.

Accordingly, in certain disclosed embodiments, a polarization wavefront LiDAR sensing approach that measures time-resolved polarization properties to recover precise distance and normal for long-range scenarios generally found in automotive scenes, as described in detail below, is disclosed. Additionally, a neural reconstruction approach for distance and normal operating directly on raw wavefronts instead of post-processed ToF peaks, and an automotive polarization LiDAR dataset including real-world data and simulation data are disclosed herein. By way of a non-limiting example, the disclosed polarization wavefront LiDAR sensing approach using the automotive polarization LiDAR dataset for long-range distance estimation and dense normal reconstruction may improve distance and normal reconstruction by up to about 41% mean absolute error and up to about 53% mean angular error, respectively.

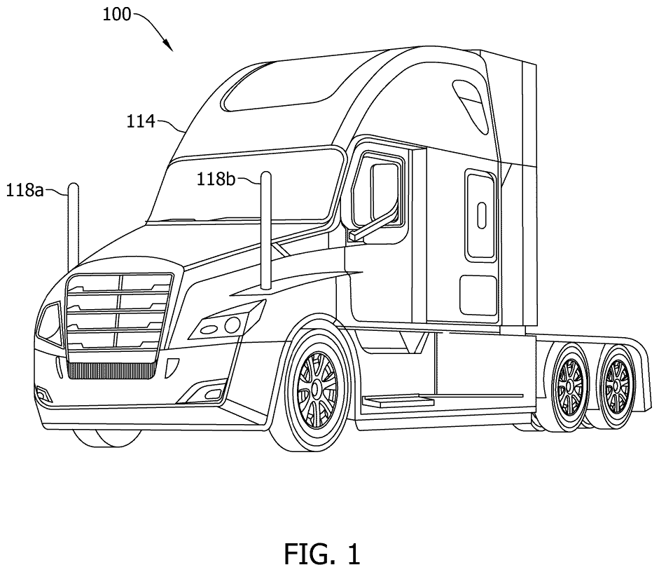

In some embodiments, the above-listed issues or drawbacks of the known systems and methods are resolved using PolLidar, as described in more detail in the present disclosure, using FIGS. 1-13 below.

FIG. 1 illustrates a vehicle 100, such as a truck that may be conventionally connected to a single or tandem trailer to transport the trailer (not shown) to a desired location. The vehicle 100 includes a cabin 114 that can be supported by, and steered in the required direction, by front wheels and rear wheels that are partially shown in FIG. 1. Front wheels are positioned by a steering system that includes a steering wheel and a steering column (not shown in FIG. 1). The steering wheel and the steering column may be located in the interior of cabin 114.

The vehicle 100 may be an autonomous vehicle, in which case the vehicle 100 may omit the steering wheel and the steering column to steer the vehicle 100. Rather, the vehicle 100 may be operated by an autonomy computing system (not shown) of the vehicle 100 based on data collected by a sensor network (not shown in FIG. 1) including one or more sensors.

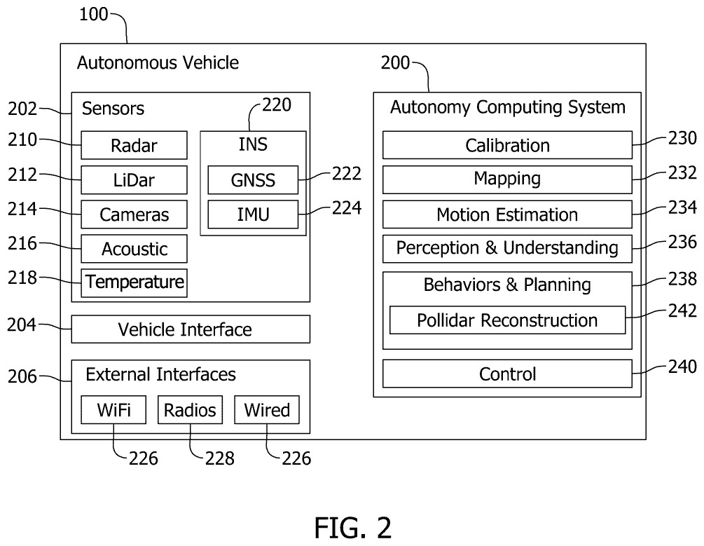

FIG. 2 is a block diagram of autonomous vehicle 100 shown in FIG. 1. In the example embodiment, autonomous vehicle 100 includes autonomy computing system 200, sensors 202, a vehicle interface 204, and external interfaces 206.

In the example embodiment, sensors 202 may include various sensors such as, for example, radio detection and ranging (RADAR) sensors 210, light detection and ranging (LiDAR) sensors 212, cameras 214, acoustic sensors 216, temperature sensors 218, or inertial navigation system (INS) 220, which may include one or more global navigation satellite system (GNSS) receivers 222 and one or more inertial measurement units (IMU) 224. Other sensors 202 not shown in FIG. 2 may include, for example, acoustic (e.g., ultrasound), internal vehicle sensors, meteorological sensors, or other types of sensors. Sensors 202 generate respective output signals based on detected physical conditions of autonomous vehicle 100 and its proximity. As described in further detail below, these signals may be used by autonomy computing system 200 to determine how to control operations of autonomous vehicle 100.

Cameras 214 are configured to capture images of the environment surrounding autonomous vehicle 100 in any aspect or field of view (FOV). The FOV can have any angle or aspect such that images of the areas ahead of, to the side, behind, above, or below autonomous vehicle 100 may be captured. In some embodiments, the FOV may be limited to particular areas around autonomous vehicle 100 (e.g., forward of autonomous vehicle 100, to the sides of autonomous vehicle 100, etc.) or may surround 360 degrees of autonomous vehicle 100. In some embodiments, autonomous vehicle 100 includes multiple cameras 214, and the images from each of the multiple cameras 214 may be processed for 3D objects detection in the environment surrounding autonomous vehicle 100. In some embodiments, the image data generated by cameras 214 may be sent to autonomy computing system 200 or other aspects of autonomous vehicle 100 or a hub or both.

LiDAR sensors 212 generally include a laser generator and a detector that send and receive a LiDAR signal such that LiDAR point clouds (or “LiDAR images”) of the areas ahead of, to the side, behind, above, or below autonomous vehicle 100 can be captured and represented in the LiDAR point clouds. LiDAR sensors 212 may include the PolLiDAR sensor disclosed herein. RADAR sensors 210 may include short-range RADAR (SRR), mid-range RADAR (MRR), long-range RADAR (LRR), or ground-penetrating RADAR (GPR). One or more sensors may emit radio waves, and a processor may process received reflected data (e.g., raw RADAR sensor data) from the emitted radio waves. In some embodiments, the system inputs from cameras 214, RADAR sensors 210, or LiDAR sensors 212 may be used in combination in perception technologies of autonomous vehicle 100.

GNSS receiver 222 is positioned on autonomous vehicle 100 and may be configured to determine a location of autonomous vehicle 100, which it may embody as GNSS data. GNSS receiver 222 may be configured to receive one or more signals from a global navigation satellite system (e.g., Global Positioning System (GPS) constellation) to localize autonomous vehicle 100 via geolocation. In some embodiments, GNSS receiver 222 may provide an input to or be configured to interact with, update, or otherwise utilize one or more digital maps, such as an HD map (e.g., in a raster layer or other semantic map). In some embodiments, GNSS receiver 222 may provide direct velocity measurement via inspection of the Doppler effect on the signal carrier wave. Multiple GNSS receivers 222 may also provide direct measurements of the orientation of autonomous vehicle 100. For example, with two GNSS receivers 222, two attitude angles (e.g., roll and yaw) may be measured or determined. In some embodiments, autonomous vehicle 100 is configured to receive updates from an external network (e.g., a cellular network). The updates may include one or more of position data (e.g., serving as an alternative or supplement to GNSS data), speed/direction data, orientation or attitude data, traffic data, weather data, or other types of data about autonomous vehicle 100 and its environment.

IMU 224 is a micro-electrical-mechanical (MEMS) device that measures and reports one or more features regarding the motion of autonomous vehicle 100, although other implementations are contemplated, such as mechanical, fiber-optic gyro (FOG), or FOG-on-chip (SiFOG) devices. IMU 224 may measure an acceleration, angular rate, or an orientation of autonomous vehicle 100 or one or more of its individual components using a combination of accelerometers, gyroscopes, or magnetometers. IMU 224 may detect linear acceleration using one or more accelerometers and rotational rate using one or more gyroscopes and attitude information from one or more magnetometers. In some embodiments, IMU 224 may be communicatively coupled to one or more other systems, for example, GNSS receiver 222 and may provide input to and receive output from GNSS receiver 222 such that autonomy computing system 200 is able to determine the motive characteristics (acceleration, speed/direction, orientation/attitude, etc.) of autonomous vehicle 100.

In the example embodiment, autonomy computing system 200 employs vehicle interface 204 to send commands to the various aspects of autonomous vehicle 100 that actually control the motion of autonomous vehicle 100 (e.g., engine, throttle, steering wheel, brakes, etc.) and to receive input data from one or more sensors 202 (e.g., internal sensors). External interfaces 206 are configured to enable autonomous vehicle 100 to communicate with an external network via, for example, a wired or wireless connection, such as Wi-Fi 226 or other radios 228. In embodiments including a wireless connection, the connection may be a wireless communication signal (e.g., Wi-Fi, cellular, LTE, 5G, 6G, Bluetooth, etc.).

In some embodiments, external interfaces 206 may be configured to communicate with an external network via a wired connection 244, such as, for example, during testing of autonomous vehicle 100 or when downloading mission data after completion of a trip. The connection(s) may be used to download and install various lines of code in the form of digital files (e.g., HD maps), executable programs (e.g., navigation programs), and other computer-readable code that may be used by autonomous vehicle 100 to navigate or otherwise operate, either autonomously or semi-autonomously. The digital files, executable programs, and other computer readable code may be stored locally or remotely and may be routinely updated (e.g., automatically, or manually) via external interfaces 206 or updated on demand. In some embodiments, autonomous vehicle 100 may deploy with all of the data it needs to complete a mission (e.g., perception, localization, and mission planning) and may not utilize a wireless connection or other connections while underway.

In the example embodiment, autonomy computing system 200 is implemented by one or more processors and memory devices of autonomous vehicle 100. Autonomy computing system 200 includes modules, which may be hardware components (e.g., processors or other circuits) or software components (e.g., computer applications or processes executable by autonomy computing system 200), configured to generate outputs, such as control signals, based on inputs received from, for example, sensors 202. These modules may include, for example, a calibration module 230, a mapping module 232, a motion estimation module 234, a perception and understanding module 236, a behaviors and planning module 238, a control module or controller 240, and a PolLidar reconstruction module 242. The PolLidar reconstruction module 242, for example, may be embodied within another module, such as behaviors and planning module 238, or perception and understanding module 236, or separately. These modules may be implemented in dedicated hardware such as, for example, an application specific integrated circuit (ASIC), field programmable gate array (FPGA), a digital signal processor (DSP), or microprocessor, or implemented as executable software modules, or firmware, written to memory and executed on one or more processors onboard autonomous vehicle 100.

The PolLidar reconstruction module 242 may perform one or more tasks including, but not limited to, accessing to the raw time-resolved polarimetric wavefront for estimating normals, distance and material properties from raw measurements to achieve precise and dense geometry reconstruction irrespective of ambient illumination or lighting conditions.

Autonomy computing system 200 of autonomous vehicle 100 may be completely autonomous (fully autonomous) or semi-autonomous. In one example, autonomy computing system 200 can operate under Level 5 autonomy (e.g., full driving automation), Level 4 autonomy (e.g., high driving automation), or Level 3 autonomy (e.g., conditional driving automation). As used herein the term “autonomous” includes both fully autonomous and semi-autonomous.

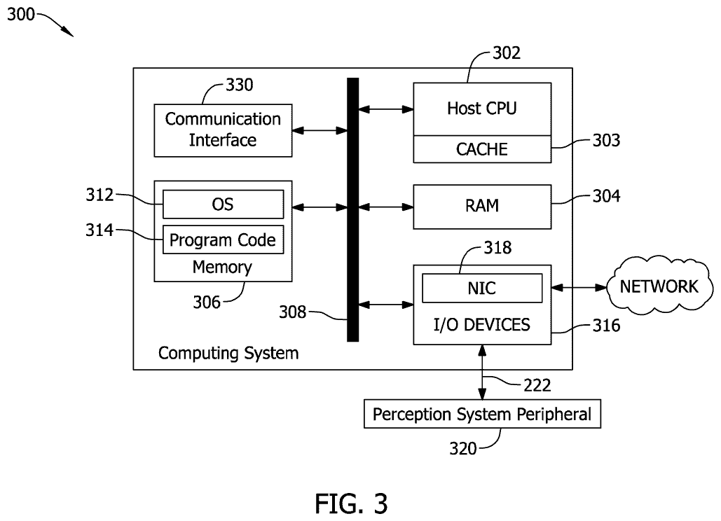

FIG. 3 is a block diagram of an example computing system 300, such as an application server at a hub. Computing system 300 includes a CPU 302 coupled to a cache memory 303, and further coupled to RAM 304 and memory 306 via a memory bus 308. Cache memory 303 and RAM 304 are configured to operate in combination with CPU 302. Memory 306 is a computer-readable memory (e.g., volatile, or non-volatile) that includes at least a memory section storing an OS 312 and a section storing program code 314. Program code 314 may be one of the modules in the autonomy computing system 200 shown in FIG. 2. In alternative embodiments, one or more section of memory 306 may be omitted and the data stored remotely. For example, in certain embodiments, program code 314 may be stored remotely on a server or mass-storage device and made available over a network 332 to CPU 302.

Computing system 300 also includes I/O devices 316, which may include, for example, a communication interface such as a network interface controller (NIC) 318, or a peripheral interface for communicating with a peripheral device 320 over a peripheral link 322. I/O devices 316 may include, for example, a GPU for image signal processing, a serial channel controller or other suitable interface for controlling a sensor peripheral such as one or more acoustic sensors, one or more LiDAR sensors, one or more cameras, one or more weight sensors, a keyboard, or a display device, etc.

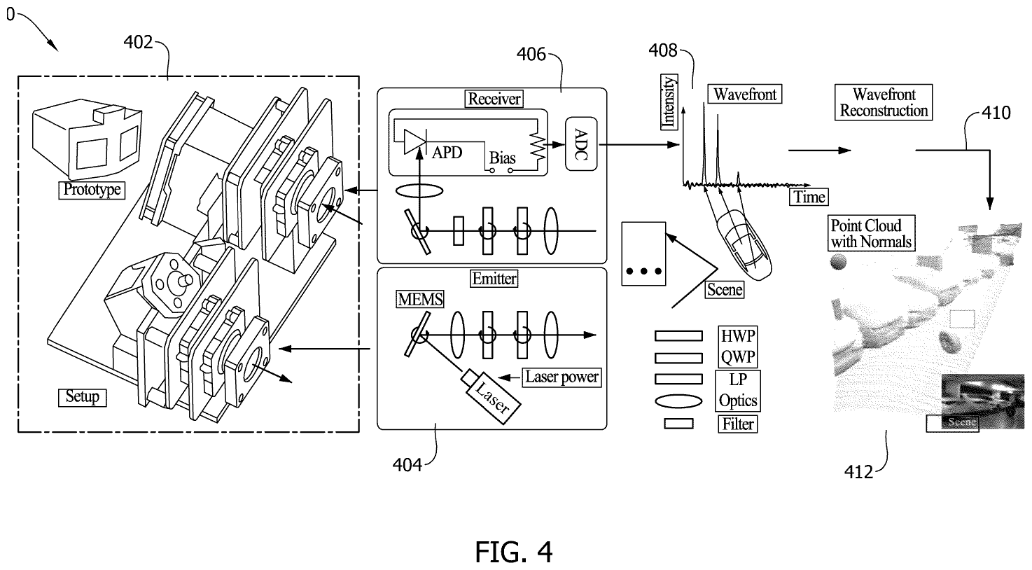

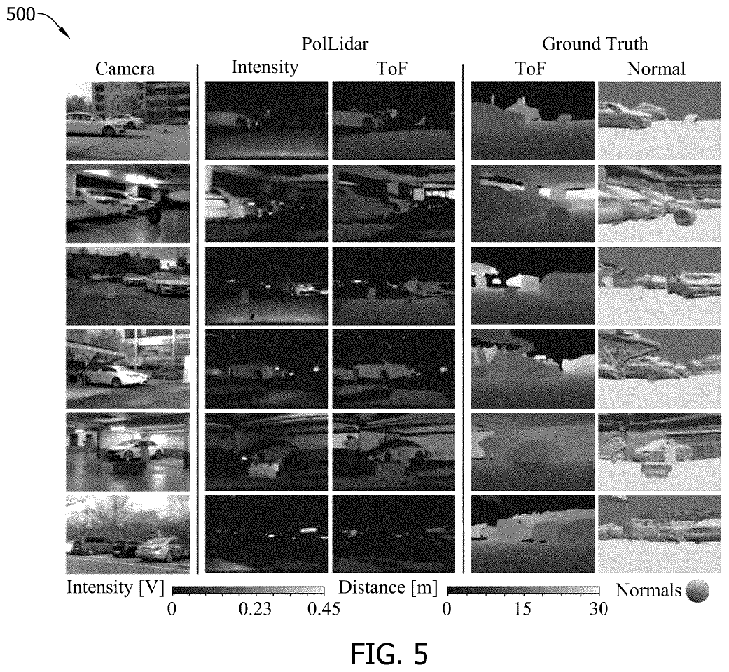

In some embodiments, a sensing modality may combine polarization analysis with LiDAR sensors for scene reconstruction as shown in FIG. 4. FIG. 4 is an illustration of an example PolLidaR sensing and scene reconstruction 400. As shown in FIG. 4, a PolLidar sensor 402 modulates the polarization of light during both emission 404 and reception 406 stages. In some embodiments, a half-wave plate (HWP) and a quarter-wave plate (QWP) may be used to emit light of a specific polarization, and a QWP and a linear polarizer (LP) may be used to determine the polarization of the received light. To capture the received signal, an analog-to-digital-converter (ADC) 414 at the avalanche photodiode (APD) 416 may be used for precise raw wavefront measurement for both the polarization characteristics and the wavefront of the light in contrast to the known LiDAR systems focusing on distance measurements. The measured raw wavefronts 408 may be used for wavefront reconstruction 410 and generate a point cloud with normal 412. The disclosed PolLidar sensor 402 is capable of operating in outdoor settings. In contrast to polarization cameras, the PolLidar sensor 402 is not limited to a discrete number of polarization states, but can measure polarization continuously by finely controlling waveplates, and for linear polarizers to perform full ellipsometry. The PolLidar reads the raw wavefront signal directly as a voltage from the APD 416 which may be used to build or generate a polarization dataset including long-range automotive scenes to assess the benefit of polarization. Along with the raw wavefronts, pairwise ground truth distance and normal information from a LiDAR reference sensor (e.g., a Velodyne VLS-128 reference sensor) may also be captured as described in detail with reference to FIG. 5.

In some embodiments, to recover scene properties from polarization wavefront measurements 408, the PolLidar sensor 402 may be combined with a reconstruction approach that operates on the raw polarimetric wavefronts to estimate surface normal and accurate distance. The estimated normal can then be utilized for predicting material properties, including index of refraction, diffuse, and specular albedo, and surface roughness. The CARLA (Car Learning to Act) simulator, which is an open-source simulator, may be extended with a realistic polarization model of light to generate a synthetic long-range polarization dataset for training purposes. However, the proposed method using PolLidar sensor for learning large scene reconstruction from polarized wavefronts may be assessed using both the synthetic and real-world data. As described herein, the proposed method using PolLidar sensor may improve distance estimation up to about 41% mean absolute error compared to conventional ToF methods and up to about 53% mean angular error for normal estimation compared SfP and point cloud baselines on automotive scenes.

FIG. 5 is an illustration of an example PolLidar dataset 500 including a long-range polarimetric lidar dataset in typical automotive scenes with object distances up to 100 meters (m). In FIG. 5, camera references images are shown on the left side. PolLidar intensity for the horizontally polarized state θ₁^{(1,2,3,4)}=0 and sensor derived ToF distances are shown in the middle of FIG. 5. Ground truth data from accumulated scans from a Velodyne VLS-128 sensor providing ToF and surface normals for comparison are shown on the right of FIG. 5.

### Polarization Lidars (PolLidar Sensors)

PolLidar sensors and polarimetric measurements are leveraged for cloud property analysis, study the bioaerosols in the atmosphere, or estimate the scattering coefficient of oceans. Additionally, a prototypical polarization lidar is combined with a temporal-polarimetric bi-directional reflectance distribution function (BRDF) model to achieve an accurate scene reconstruction. Further, a polarimetric indirect ToF imaging method that utilizes polarization is used to improve depth estimations through scattering media. However, the imaging technique, i.e., the design of the optical path and the indirect ToF measurement principle fundamentally limit these devices to indoor usage. In contrast, the scene reconstruction method disclosed herein using PolLidar can be used in large outdoor scenes up to 100 m.

Scene Reconstruction with Passive Polarization Sensors

Shape from polarization (SfP) methods are used for scene reconstruction from polarization images captured by linear-polarization cameras based upon relationship between the polarization of reflected light and the surface normals. The known SfP methods focus on estimating the surface normal of objects under assumptions of either pure specular reflection or pure diffuse reflection, and usually assume an unpolarized light source and suffer from polarization ambiguity issues. Additionally, deep learning is leveraged to solve the ambiguity problem. Further, the neural network trained using real-world datasets can better distinguish the ambiguity and mitigate the need for inputting unknown material properties such as refractive index. Additionally, joint optimization of appearance, normals, and refractive index is also performed. A learning-based inverse learning framework is used with front-flash illumination, and polarization is combined with implicit neural representations to collectively reconstruct the geometry and appearance from multiple images using reconstruction methods that focus on scenes with few objects that are placed to exhibit string polarization cues with high degree of polarization (DoP). In outdoor scenes, however, the DoP varies significantly limiting the quality of reconstruction to high DoP regions. However, the reconstruction method using PolLidar as disclosed herein functions in both high and low DoP regions by adaptively exploiting polarization cues.

Passive polarization sensors are combined with other imaging modalities by utilizing normal from polarization to enhance the details of depth from a passive sensor (e.g., Microsoft Kinect sensor), and fill in missing regions of depth maps using polarization information. In some examples, polarization cues are leveraged to augment low-quality depth maps from two-view stereo, reciprocal image pairs, multi-view stereo, or LiDAR sensors. Stereo polarimetric methods are known which utilize two polarization images to solve the ambiguity in SfP. However, these polarimetric methods that are based on passive polarization sensors are dependent on ambient light and fail or struggle in low-light conditions. The active sensing method using PolLidar disclosed herein allows for accurate reconstructions independently of ambient lighting conditions.

### Polarimetric Wavefront Lidar (PolLidar)

Polarimetric lidars are employed for gathering polarization data over extensive ranges, for example, often spanning several kilometers, but at the cost of spatial resolution. While polarimetric lidars for scene reconstruction usually support high spatial resolution, but their range is limited to a few meters. Accordingly, a PolLidar sensor shown in FIG. 4 uniquely provides high spatial resolution over extensive ranges. By way of a non-limiting example, the PolLidar sensor allows for a balanced performance optimal for both long-range capabilities up to 223 m and high spatial resolution of 150 rows and 236 columns over an 23.95° and 31.53° vertical and horizontal field-of-view and making it particularly suitable for autonomous driving applications.

In some embodiments, the disclosed PolLidar sensor differs from the ToF LiDAR sensor as separate modules for emission and reception are used in the disclosed PolLidar sensor instead of a shared optical setup. The separate modules for emission and reception allows for a larger optical aperture in each module, which enhances optical sensitivity and extends the operational range in outdoor scenarios. Further, instead of the galvo mirror, an oscillating microelectromechanical systems (MEMS) micro-mirror is used for scene scanning to reduce the system size while increasing the scanning speed drastically.

By way of a non-limiting example, to make outdoor applications possible, the PolLidar sensor may be operated at a wavelength of 1064 nm, and a narrow bandpass filter may be added. The narrow bandpass filter may be adapted to exclude the visible band (or to suppress ambient light) and render emitted light invisible to the human eye, while aligning with automotive illumination standards. The maximum power output of the PolLidar sensor may be according to Class-1 eye safety regulations, and the laser power may be adjusted according to scenario requirements for offering a balance between achieving a maximum range and minimizing saturation as a level of control. In the off-the-shelf LiDAR sensors, the balance between achieving the maximum range and minimizing saturation as the level of control is not available.

In some embodiments, on the emission side, the horizontally polarized laser light undergoes modulation by passing through both a HWP and a QWP, and on the receiver side, a receiver module is designed to capture changes in polarization, facilitated by a sequence of a QWP and an LP, and a bandpass filter, as shown in FIG. 4. Further, the rotation of each filter is finely adjustable in increments of 0.01°. Additionally, a back-side illuminated APD with an adjustable bias for sensitivity adjustments and reading the raw signal with an attached ADC may be used. The ADC may have a sampling rate of 1Gs/s, which allows to measure raw wavefronts with a length of 1488 bins of 1 ns width, i.e., 15 cm per bin, and range of 223 meters. Additionally, a neural scene reconstruction method, as described in detail below, for reconstructing the scene from polarized raw wavefronts may be used.

### Polarimetric Lidar Forward Model

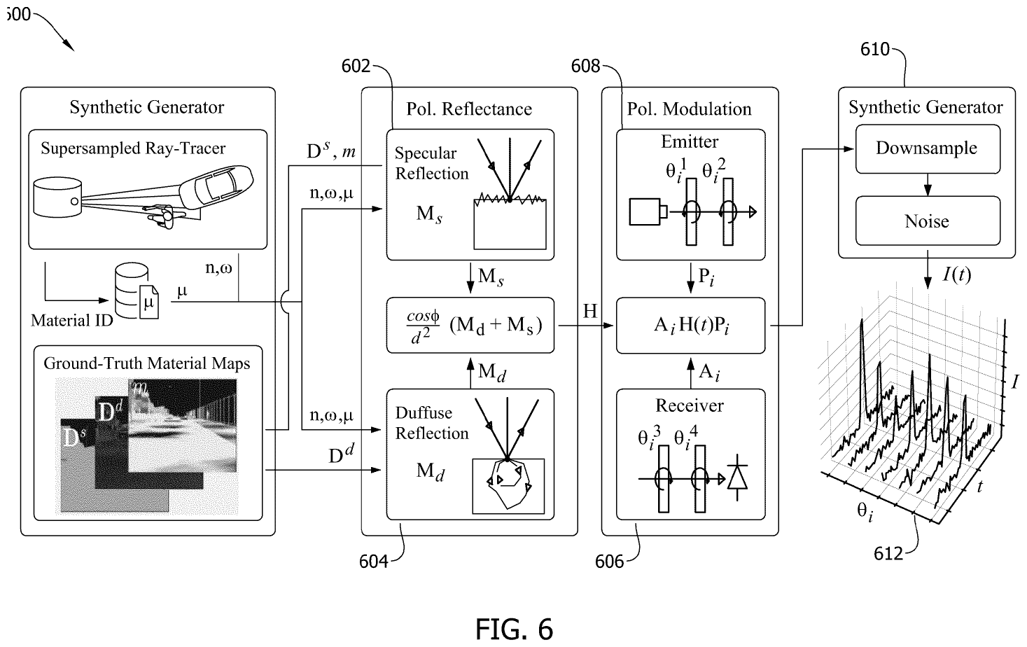

In some embodiments, polarization may be modeled as a Stokes-Mueller formalism, with light and reflectance described by a stoke vector s∈R^{4×1} and a Mueller matrix M∈R^{4×4}. A temporal-polarimetric reflectance model M(τ, ωᵢ, ωₒ) describing how light polarization and intensity change when impinging on a surface with given incident and outgoing direction of light (ωᵢ and ωₒ), and with temporal delay (τ) of diffuse reflection As indicated in FIG. 6, the reflectance M may be modeled as a sum of specular and diffuse reflection (Mₛ and M_{d}), as

$$M ( τ , {ω}_{i} , {ω}_{o} ) = {M}_{s} ( τ , {ω}_{i} , {ω}_{o} ) + {M}_{d} ( τ , {ω}_{i} , {ω}_{o} ) , \qquad Eq . 1$$

$${M}_{s} ( τ , {ω}_{i} , {ω}_{o} ) = \frac{D ( {θ}_{h} ; m ) G ( {θ}_{i} , {θ}_{o} ; m )}{4 cos {θ}_{i} cos {θ}_{o}} {D}^{s} ( τ ) {F}_{R} , \qquad Eq . 2$$

$${M}_{d} ( τ , {ω}_{i} , {ω}_{o} ) = {C}_{n \to o} {F}_{T}^{o} {D}^{d} ( t ) {F}_{T}^{i} {C}_{i \to n} , \qquad Eq . 3$$

In Eq. 1, Eq. 2, and Eq. 3 above, where θₕ=cos⁻¹(h·n), θᵢ=cos⁻¹(n·ωᵢ), θₒ=cos⁻¹(n·ωₒ) and n is the surface normal. D and G are functions to describe the surface, where m is the roughness. C_{i→n} and C_{n→o} are the coordinate-conversion Mueller matrices, and Fⁱ_{T}, F^{o}_{T} are the Fresnel transmission Mueller matrices for incident and outgoing light, depending on refractive index η. D^{s} and D^{d} are the depolarization Mueller matrices for specular and diffuse reflection.

For long-range working distance, the incident and outgoing direction of light in PolLidar sensor may be assumed to be identical, and the reflectance model with a single viewing direction ω=ωᵢ=ωₒ, may be approximated. After scaling M by the cosine shading term cos ϕ and attenuation such that H (τ, ω, ω)=(cos ϕ/d²) M (τ, ω, ω), the lidar forward model can be written as,

$$I ( t , ω ) = {[ {\int }_{0}^{{t}^{′}} H ( {t}^{′} , ω , ω ) {s}_{laser} ( ω , {t}^{′} - τ ) d τ ]}_{0} , \qquad Eq . 4$$

In Eq. 4 above,

$${t}^{′} = t - \frac{2 d}{c} ,$$

where d is the distance between laser and scene, and c is the speed of light. Slaser denotes the Stokes vector of the emitted laser light. The operator [ . . . ]₀ denote staking the firs element of the resulting vector.

FIG. 6 is an illustration of an example PolLidar forward model and simulator 600. Temporal polarimetric reflectance of the scene can be modeled as the sum of specular Mₛ 602 and diffuse M_{d} reflection 604. Receiver 606 and emitter 608 of the PolLidar can be described with the Mueller matrices Pᵢ and Aᵢ that are functions of the rotation angles θᵢ^{(1,2,3,4)} of HWP, QWPs and LP, respectively. The resulting PolLidar forward model may be employed in a simulator 610 based on CARLA that generates synthetic polarimetric raw wavefronts 612. Further, material properties and normals may be extracted from CARLA and inputted into the forward model. The resulting temporal wavefronts are subsequently down sampled in spatial dimension to model beam divergence. Additionally, noise is added to simulate APD and ADC.

In some embodiments, rotating ellipsometry may be used to infer all elements of the Stokes vectors. As illustrated by FIG. 6, a HWP and a QWP are rotated to modulate the polarization of the emitted light. Analogous on the receiving side, a QWP and a LP are used to measure light with a specific polarization incident on the APD. Hence, the image formation of the PolLidar may be modelled as shown in Eq. 5.

$${{I}_{i} ( t , ω ) ) = [ {A}_{i} H ( {t}^{′} , ω ) {P}_{i} {s}_{laser} ( 0 ) , 0 ) ]}_{0} , \qquad Eq , 5$$

In Eq. 5 above, Aᵢ and Pᵢ are the i-th Mueller matrices of the analyzing optics and the polarizing optics defined as Aᵢ=L(θᵢ⁴)Q(θᵢ³) and Pᵢ=Q(θᵢ²)W(θᵢ¹), with θᵢ^{(1,2,3,4)} as the rotation angles of the emitter HWP and QWP and the receiver QWP and LP, respectively. Here, W, Q, and L are he Mueller matrices of the HWP, QWP, and LP.

### Polarimetric Lidar Simulator

In some embodiments, in order to use the PolLidar in a learning-based framework, sufficient amounts of training data are required. However, the finely controllable waveplates come at the cost of longer measurement times as the motors move relatively slow. To acquire a large polarization wavefront dataset, the lidar forward model from Eq. 5 may be integrated into the CARLA simulator to generate vast amounts of synthetic training data. Specifically, the full wavefront lidar model may be extended for CARLA simulator. As presented in FIG. 6, the material properties m, D^{s} and D^{d} may be extracted using custom material cameras. However, materials in CARLA simulator do not have refractive indices u assigned by default, and that is circumvented by extending the ray-tracer to return the material ID of each hit point. Based on the material ID, a loop-up may be performed for the corresponding refractive index μ in a database. Additionally, the ray-tracer may be extended to return normals n for each hit point.

With obtained material properties and normal, the scene is simulated using the polarimetric lidar forward model. To model the beam divergence of the laser beam, neighboring rays are down sampled to eventually render the temporally resolved polarimetric raw wavefronts. Next, shot and read-out noise is modelled by applying Poisson and Gaussian noise to the wavefronts, respectively. The noise characteristics are tuned such that they closely resemble the real device.

### Neural Polarization Lidar Reconstruction

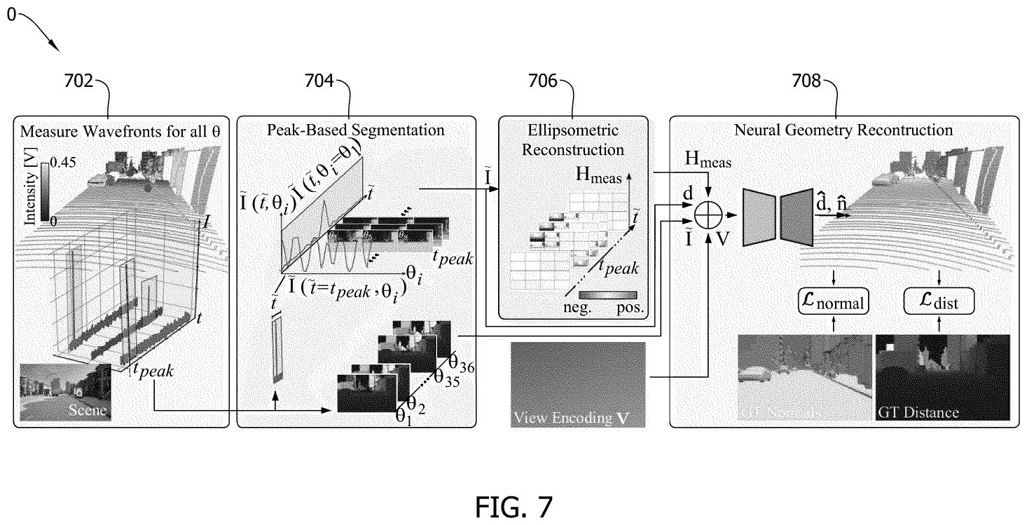

To leverage polarized raw wavefront data, a learning-based approach for reconstructing normals and distance as presented by FIG. 7 may be used in which the wavefronts may be preprocessed as described below followed by training a neural network to predict normals and distance from polarized wavefronts as discussed below.

FIG. 7 is an illustration of an example neural polarization wavefront LiDAR reconstruction 700. As shown in FIG. 7, raw polarization wavefronts of the scene I 702 are captured and a peak-based segmentation technique 704 is applied to obtain a sliced polarization wavefront Ĩ and distance priors d. Via ellipsometric reconstruction 706, a sliced Mueller matrix Hₘₑₐₛ is estimated. Finally, all the polarization priors with viewing direction V are concatenated as the input to a neural network predicting distance and normals for neural geometry reconstruction 708 of the scene. The network has a normal loss [symbol] ₙₒᵣₘₐₗ and a distance loss [symbol] _{dist}.

### Preprocessing Wavefronts

When capturing a frame, rotating ellipsometry is performed by collecting raw wavefronts for 36 different rotation angles θᵢ subsequently denoted as I={Iᵢ} where i=1 . . . 36, and where Iᵢ∈ [symbol] ^{H×W×T} with H=150, W=236 and T=1488.

The temporal resolution T and the repeated measurement for each angle θᵢ; results in 53,568 samples for each ray in I. To tackle this large dimensional space, first peak-based segmentation is performed to obtain sliced wavefronts as shown in FIG. 7. Specifically, to reduce the temporal dimension, the peak within the wavefront is located, and then a window of size 51 centered around the peak is segmented that results in a sliced wavefront Ĩ={Ĩᵢ} where i=1 . . . 36 and Ĩ_{I}∈ [symbol] ^{H×W×51}. Further, temporal index of the peak tₚₑₐₖ is preserved as it contains distance information d∈ [symbol] ^{36×H×W×1}.

As the raw wavefront Ĩ implicitly encodes the polarization optics from emitter and receiver, ellipsometric reconstruction is applied to recover the time-dependent Mueller matrix H. Temporal measurements Iᵢ collected at various rotation angles of the polarization optics are used to invert the image formation model presented in Eq. 5. Accordingly, the Mueller matrix Hₘₑₐₙₛ∈ [symbol] ^{H×W×51×16} is recovered by solving a least-squares optimization problem as follows:

$$\begin{matrix}Minimize {\sum }_{\dot{l} = 1}^{N} {( {I}_{i} - {[ {A}_{i} , {H}_{m e a s} , {P}_{i} {s}_{l a s e r} ]}_{0} )}^{2} , \\ {H}_{m e a s}\end{matrix} \qquad Eq . 6$$

### Neural Geometry Reconstruction

In some embodiments, using the pre-processed signals, the geometry of the scene is reconstruction by flattening and concatenating the pre-processed signal as input x to a neural reconstruction network such that:

$$x = \tilde{I} ⊕ d ⊕ {H}_{m e a s} ⊕ V , \qquad Eq . 7$$

In Eq. 7 above, ⊕ is the concatenation symbol and V the viewing direction. Further, normals \hat{n} and distance \hat{d} are predicted with a neural network. By way of a non-limiting example, the neural network may be a variation of a TransUnet that combines the U-Net and transformer architecture components. Additionally, and by way of a non-limiting example, 3 encoder layers are used to encode the features, 8 transformer layers, and 3 decoder layers with skip-connection to predict normals and distance are used.

In some embodiments, the neural network may be trained by supervising normals and distance predictions with a cosine similarity loss for the surface normal and a mean absolute loss for distance.

$${{ℒ}_{normal} = \vert 1 - ( c ⊙ {n}_{gt} ) \cdot ( c ⊙ \hat{n} ) ) \vert}_{1} , \qquad Eq . 8$$

$${ℒ}_{dist} = {\vert c ⊙ {d}_{gt} - c ⊙ \hat{d} \vert}_{1} , \qquad Eq . 9$$

In Eq. 8 and Eq. 9, c is the confidence estimate for the normals as ground truth normals are not reliable measurements. By way of a non-limiting example, the scene reconstruction method using PolLidar sensor may be implemented using a neural network in PyTorch. The neural network may be trained, for example, for 500 epochs on a Nvidia A100 GPU. Additionally, Adam optimizer with an initial learning rate of 1e⁻⁴ and the batch size of 1 may be used. Images may be cropped to 128×128 patches in each iteration for data augmentation. Furthermore, different laser powers and biases are applied during training to increase robustness against saturation and low-intensity readings.

### Exemplary Setup and Assessment of Reconstruction Method Using PolLidar

In some embodiments, the effectiveness of the disclosed reconstruction method may be assessed or validated using synthetic data with perfect ground truth and material estimation before validating the method with the PolLidar described herein. Finally, the different inputs may be ablated to show the benefit of polarized raw wavefronts.

### Synthetic Evaluation

The neural geometry reconstruction method disclosed herein may be validated on synthetic data with perfect ground truth and compared against three SfP baseline methods to evaluate the quality of the reconstructed normals. By way of a non-limiting example, the baseline method may include a baseline method designed for object-level scene reconstruction for a polarimetric ToF prototype that fits the recovered Mueller matrix Hₘₑₐₛ to the polarimetric lidar forward model by jointly estimating material properties and normals. Additionally, the disclosed neural geometry reconstruction method may also be compared against the classical SfP approach, which recovers surface normals from the DoP by assuming a scene-wide constant refractive index and diffusive reflection.

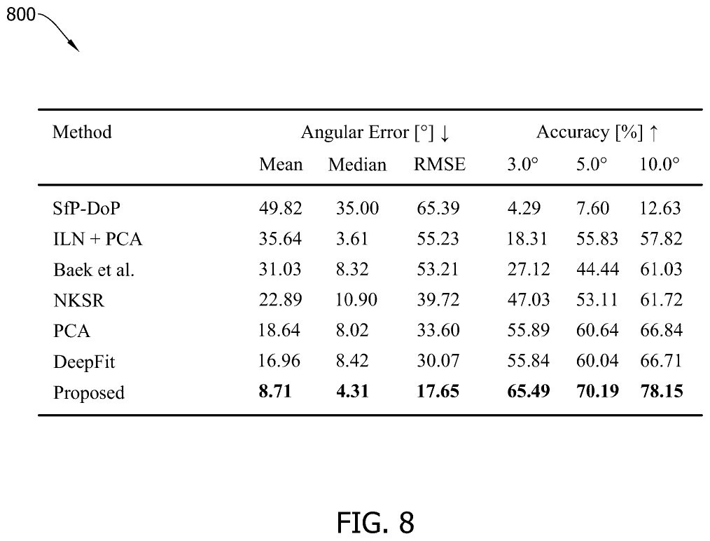

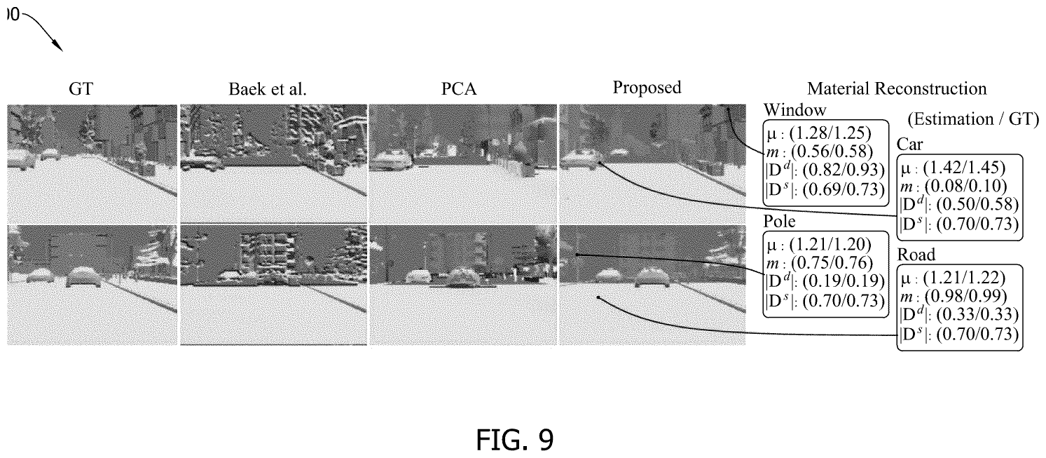

FIG. 8 is an example table showing quantitative evaluation for normal on synthetic data. The SfP baseline method is unable to reconstruct normals in real-world because the underlying assumptions do not translate to real-world scenarios. Additionally, baseline methods designed for object-level ToF imaging fails in low DoP regions. Principal component analysis (PCA) achieves improved results but with quality depending on point cloud density. In comparison, the scene reconstruction method using PolLidar disclosed herein leverages both the neighborhood of points and the polarization cues and outperforms the baselines method by having accuracy percentage of points with angular errors below threshold. As shown in FIG. 8, some baseline methods do not generalize well to outside scenes due to real-world geometry exhibiting regions of high but also very low DoP. Low DoP regions occur when the surface normal and the viewing direction of the lidar align as highlighted by the qualitative finding in FIG. 9.

FIG. 9 is an illustration of example qualitative evaluation on synthetic data 900. As shown in FIG. 9, baseline methods are unable to reconstruct normals in areas with low DoP, e.g., walls of buildings facing the sensor. PCA applied in this setting is strongly dependent on point cloud density, and, therefore, distant poles and cars in the second row cannot be reconstructed accurately. However, the scene reconstruction method using PolLidar disclosed herein leverages polarization cues to reconstruct normals in sparse regions and is robust against low DoP areas. Further, accurate material properties for different surfaces and objects shown on the right in FIG. 9 may be estimated.

While some baseline methods operate on a per-ray basis, baseline method based on PCA for normal reconstruction may be compared with a point-cloud based method that considers a neighborhood of points. The method considering the neighborhood of points performs well in areas with flat geometry and high point density but degrades significantly at long ranges with sparse distance, e.g., cars in far distances in the second row of FIG. 9 and geometry transition regions, e.g., the area between road and car. PCA also struggles with thin structures like the pole shown in the second row of FIG. 9. The scene reconstruction method using PolLidar as described herein leverages the additional cues from polarization to resolve normals in regions with sparse points and achieve satisfying reconstruction results for regions with little polarization information by taking a local neighborhood and cues from a normal-dependent widened pulse into account. As a result, the scene reconstruction method using PolLidar outperforms PCA by up to about 53% on the mean angular error as shown in FIG. 8.

In some embodiments, for evaluating distance estimation, the scene reconstruction method using PolLidar disclosed herein is compared against the conventional argmax-peak-finding typically performed directly on an electronic computing device. The conventional argmax-peak-finding approach is limited by the temporal resolution of the sensor and has a mean absolute distance error of 32 cm. The disclosed scene reconstruction method using PolLidar method leverages the raw wavefront data and the relationship between distance and normals to generate high-quality distance and yields a mean absolute distance error of about 19 cm outperforming the conventional approach by 41% mean absolute error.

### Material Property Estimation

In some embodiments, with estimated surface normals, the material properties, namely index of refraction μ, rough-ness m and the depolarization matrices D^{s} and D^{d}, of the polarimetric lidar forward model are reconstructed. To this end, we follow Baek et al. [7] and estimate material properties by rendering the Muelller matrix H_{render}=H^{s}_{render}+H render that explains the reconstructed Mueller matrix Hₘₑₐₛ. In the large scenes, the DoP is mostly governed by diffuse reflection, which heuristic is leveraged to disentangle the specular and diffusive Mueller matrices. The minimization problem may be represented as:

$$Eq . 10$$

$$\begin{matrix}Minimize {λ}^{d} {\vert {c}_{dop} ⊙ ( {H}_{m e a s} - {H}_{r e n d e r}^{d} ) \vert}_{1} + {λ}^{s} {\vert ( {H}_{m e a s} - {H}_{r e n d e r}^{d} ) - {H}_{r e n d e r}^{s} \vert}_{1} , \\ μ , m , \vert {D}^{s} \vert , \vert {D}^{d} \vert\end{matrix}$$

In Eq. 10 above, Δ^{d} and Δ^{s} are scalar weights, and C_{dop} is a mask focusing on regions with high diffusive DoP. The weights are chosen such that in the first phase of the minimization, the diffusive loss drives the estimation of the index of refraction μ which later helps to better disentangle material properties that occur solely in the specular component of the Mueller matrix. By way of a non-limiting example, during simulation, the scalar amplitude, denoted by |D^{s}| and |D^{d}|, of the depolarization matrices vary and are subsequently optimized for.

FIG. 9 validates that disclosed reconstruction approach is able to successfully recover the material properties of different objects and surfaces. Further, because the surface normal are not optimized, it is validated that the quality of the reconstructed normals as recovering material properties without accurate normals is infeasible.

### Experimental Evaluation

In some embodiments, the disclosed reconstruction approach is validated on real-world data using a pair of the PolLidar sensor with a Velodyne VLS-128 reference lidar. FIG. 5 shows PolLidar data with ground truth distance and normals. By way of a non-limiting example, 60 frames are captured with 3 biases each and scene-adjusted laser power paired with ground-truth distance and normal information. For ground truth, point clouds from the reference lidar are accumulated, dense lidar maps are generated, and normal from the meshed lidar map are extracted. Additionally, the proposed neural geometry reconstruction approach may be finetuned for ten epochs and hold out a dedicated testset.

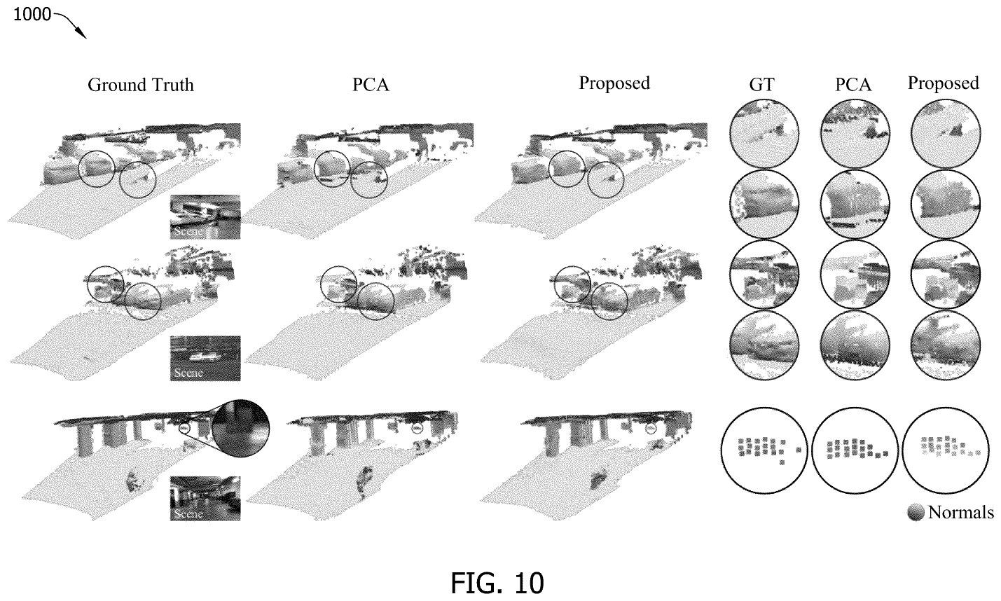

FIG. 10 is an example illustration of qualitative evaluation on experimental data. As shown in FIG. 10, PCA applied on measured captures from the disclosed PolLidar results in erroneous predictions of surface normals, which are especially prominent for the fine structures visible in the zoom-ins of the first two rows shown in FIG. 10, for example, the transition of ground and metal ramp in the first row and the metal roof support in the second row. In contrast, the disclosed scene reconstruction method using PolLidar is able to resolve these fine details. In the last row in FIG. 10, a lost cargo scenario is shown with an upright object blocking the road in 50 m distance. The disclosed method using PolLidar, however, correctly classifies the object as facing toward the vehicle, whereas PCA predicts a flat surface with downwards oriented normals.

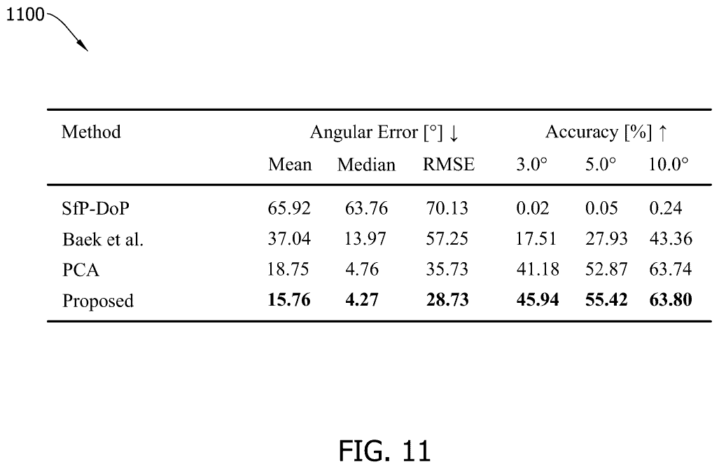

As described herein, FIG. 10 reports qualitative reconstructions of the proposed approach on the testset. Similar to the synthetic evaluations, PCA introduces artifacts, whereas the disclosed scene reconstruction approach using PolLidar is able to recover the surface geometry correctly, e.g., as shown in the first row of FIG. 10 for the transition area between ground and metal ramp, and is able to reconstruct normals in sparse regions, e.g., for the metal support structure of the roof in the second row. These finding regarding qualitative reconstructions are consistent with the quantitative results shown in FIG. 11, where the disclosed scene reconstruction method using PolLidar outperforms the best baseline method by about 16% mean angular error. For autonomous driving, accurate normals have another valuable application in the detection of lost-cargo objects, where objects blocking the road well beyond 100 m are required to be detected. As lidar is inherently sparse in these regions, lost cargo objects have only a single digit number of points preventing accurate detection. As such, accurate normals allow to distinguish obstacles from the road and are crucial to determine if areas of the road are passable. Such a scenario is shown in the last row of FIG. 10, where normals of a roadblock in 50 m distance are predicted correctly as facing towards the vehicle by the proposed approach. In contrast, the baseline methods based on the PCA estimates the roadblock as flat with downward pointing normals likely misclassifying the object as passable resulting in sudden breaking of the vehicle.

FIG. 11 is an example table showing quantitative evaluation for normal on experimental data. As shown in FIG. 11, for normal reconstruction with the real device, comparable trends to synthetic data are observable. Due to noisier ground truth and sensor imperfections, the overall error is slightly larger. However, the disclosed scene reconstruction method using PolLidar recovers accurate normals on real experimental data, outperforming all baseline approaches and increasing accuracy as percentage of points with angular errors is below threshold. For distance estimation, the mean absolute error of conventional argmax-peak-finding amounts to about 24 cm, whereas the disclosed scene reconstruction method using PolLidar yields a mean absolute error of about 20 cm, and thereby outperforming the conventional distance estimation by about 17%.

### Ablation Experiment Results

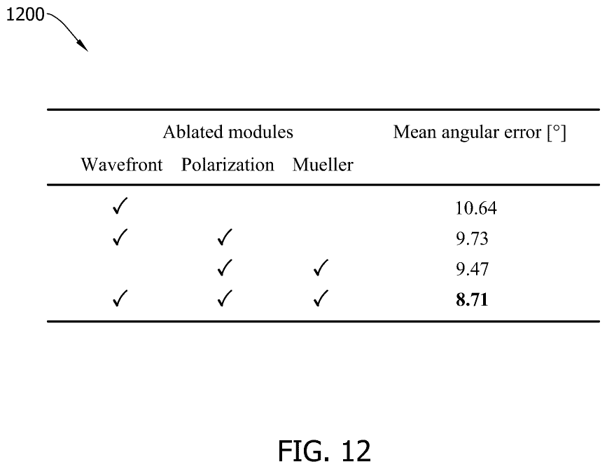

To further analyze the impact of polarization cues, the polarization information may be removed by replacing the raw wavefronts Ĩ with the mean over the different θᵢ. Removing the polarization cues, mean angular error is increased by about 22% as shown by FIG. 12.

FIG. 12 is an example table showing results of ablation experiments for different modules on synthetic data. The quality of the disclosed scene reconstruction method using PolLidar degrades significantly when the polarization information is withheld, as shown in FIG. 12. However, ellipsometric reconstruction improves the performance effectively by proving the Mueller matrix. In addition, removing the wavefront (i.e., set window size=1) also degrades the normal estimation performance. Furthermore, the ellipsometric reconstruction is ablated to provide the Mueller matrix and remove them from the inputs. As the network needs to learn to disentangle the polarization optics of the emitter and receiver from the scene, the mean angular error of surface normal increases by about 12%. Finally, the impact of using raw wavefronts is analyzed by setting the window size to 1. FIG. 12 shows that the wavefront carries crucial information for scene reconstruction.

Accordingly, the present disclosure describes a long-range polarization wavefront lidar sensor that measures time-resolved polarization-modulated wavefronts. To recover high-resolution scene information from these raw polarimetric wavefronts, a learning-based approach is devised to re-cover distance, surface normals, and material properties. To train and evaluate the disclosed method, a large synthetic dataset, and a real-world long-range dataset with paired raw lidar data, ground truth depth and normal maps is introduced. The disclosed scene reconstruction method is validated as improving normal and depth reconstruction by about 53% and 41% in mean angular error and mean absolute distance error compared to existing shape-from-polarization (SfP) and ToF methods. By way of a non-limiting example, the disclosed polarimetric wavefront sensing method may be used with a sequential acquisition setup, and parallelized acquisition setups that capture a subset of polarization states, allowing for real-time polarimetric lidar captures may also be feasible.

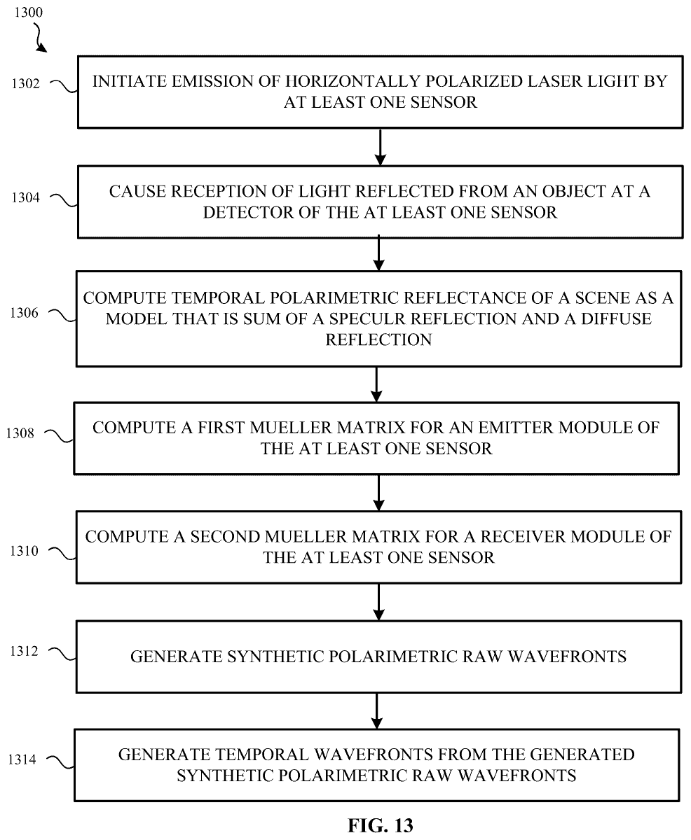

FIG. 13 illustrates an exemplary flow-chart 1300 of method operations performed by an autonomy computing system 200 or a computing system 300. The method operations may include initiating 1302 emission of horizontally polarized laser light by at least one sensor. The at least one sensor may be a PolLidar sensor including an emitter module and a receiver module that is separate from the emitter module. The emitter module may have an optical emitter aperture for emitting the horizontally polarized laser light. The method operations may include causing 1304 reception of light reflected from an object at a detector of the at least one sensor. By way of a non-limiting example, the reflected light is captured via an optical receiver aperture that is separate from the optical emitter aperture.

The method operations may include computing 1306 temporal polarimetric reflectance of the scene as a model that is a sum of a specular reflection and a diffuse reflection. Since computing 1306 temporal polarimetric reflectance of the scene as the model such as the polarimetric lidar forward model is described in detail herein, those details are not repeated for brevity. The method operations may include computing 1308 a first Mueller matrix for the emitter module of the at least one sensor, and computing 1310 a second Mueller matrix for the receiver module of the at least sensor. As described herein, the first Mueller matrix is a function of a HWP and a QWP, and the second Mueller matrix is a function of a QWP and a LP. The method operations may include generating 1312 synthetic polarimetric raw wavefronts. Synthetic polarimetric waveforms are generated based at least in part upon the computed first and second Mueller matrices and the computed temporal polarimetric reflectance of the scene, as described herein, with regards to FIG. 6. Further, the method operations may include generating 1314 temporal wavefronts from the generated synthetic polarimetric raw wavefronts to model beam divergence and scene reconstruction, as described herein, with regards to FIG. 6.

Various functional operations of the embodiments described herein may be implemented using machine learning algorithms, and performed by one or more local or remote processors, transceivers, servers, and/or sensors, and/or via computer-executable instructions stored on non-transitory computer-readable media or medium.

In some embodiments, the machine learning algorithms may be implemented, such that a computer system “learns” to analyze, organize, and/or process data without being explicitly programmed. Machine learning may be implemented through machine learning methods and algorithms (“ML methods and algorithms”). In one exemplary embodiment, a machine learning module (“ML module”) is configured to implement ML methods and algorithms. In some embodiments, ML methods and algorithms are applied to data inputs and generate machine learning outputs (“ML outputs”). Data inputs may include but are not limited to images. ML outputs may include, but are not limited to identified objects, items classifications, and/or other data extracted from the images. In some embodiments, data inputs may include certain ML outputs.

In some embodiments, at least one of a plurality of ML methods and algorithms may be applied, which may include but are not limited to: linear or logistic regression, instance-based algorithms, regularization algorithms, decision trees, Bayesian networks, cluster analysis, association rule learning, artificial neural networks, deep learning, combined learning, reinforced learning, dimensionality reduction, and support vector machines. In various embodiments, the implemented ML methods and algorithms are directed toward at least one of a plurality of categorizations of machine learning, such as supervised learning, unsupervised learning, and reinforcement learning.

In one embodiment, the ML module employs supervised learning, which involves identifying patterns in existing data to make predictions about subsequently received data. Specifically, the ML module is “trained” using training data, which includes example inputs and associated example outputs. Based upon the training data, the ML module may generate a predictive function which maps outputs to inputs and may utilize the predictive function to generate ML outputs based upon data inputs. The example inputs and example outputs of the training data may include any of the data inputs or ML outputs described above. In the exemplary embodiment, a processing element may be trained by providing it with a large sample of images with known characteristics or features or with a large sample of other data with known characteristics or features. Such information may include, for example, information associated with a plurality of images and/or other data of a plurality of different objects, items, or property.

In another embodiment, a ML module may employ unsupervised learning, which involves finding meaningful relationships in unorganized data. Unlike supervised learning, unsupervised learning does not involve user-initiated training based upon example inputs with associated outputs. Rather, in unsupervised learning, the ML module may organize unlabeled data according to a relationship determined by at least one ML method/algorithm employed by the ML module. Unorganized data may include any combination of data inputs and/or ML outputs as described above.

In yet another embodiment, a ML module may employ reinforcement learning, which involves optimizing outputs based upon feedback from a reward signal. Specifically, the ML module may receive a user-defined reward signal definition, receive a data input, utilize a decision-making model to generate a ML output based upon the data input, receive a reward signal based upon the reward signal definition and the ML output, and alter the decision-making model so as to receive a stronger reward signal for subsequently generated ML outputs. Other types of machine learning may also be employed, including deep or combined learning techniques.

In some embodiments, generative artificial intelligence (AI) models (also referred to as generative machine learning (ML) models) may be utilized with the present embodiments and may the voice bots or chatbots discussed herein may be configured to utilize artificial intelligence and/or machine learning techniques. For instance, the voice or chatbot may be a ChatGPT chatbot. The voice or chatbot may employ supervised or unsupervised machine learning techniques, which may be followed by, and/or used in conjunction with, reinforced or reinforcement learning techniques. The voice or chatbot may employ the techniques utilized for ChatGPT. The voice bot, chatbot, ChatGPT-based bot, ChatGPT bot, and/or other bots may generate audible or verbal output, text, or textual output, visual or graphical output, output for use with speakers and/or display screens, and/or other types of output for user and/or other computer or bot consumption.

In some embodiments, various functional operations of the embodiments described herein may be implemented using an artificial neural network model. The artificial neural network may include multiple layers of neurons, including an input layer, one or more hidden layers, and an output layer. Each layer may include any number of neurons. It should be understood that neural networks of a different structure and configuration may be used to achieve the methods and systems described herein.

In the exemplary embodiment, the input layer may receive different input data. For example, the input layer includes a first input a₁ representing training images, a second input a₂ representing patterns identified in the training images, a third input a₃ representing edges of the training images, and so on. The input layer may include thousands or more inputs. In some embodiments, the number of elements used by the neural network model changes during the training process, and some neurons are bypassed or ignored if, for example, during execution of the neural network, they are determined to be of less relevance.

In some embodiments, each neuron in hidden layer(s) may process one or more inputs from the input layer, and/or one or more outputs from neurons in one of the previous hidden layers, to generate a decision or output. The output layer includes one or more outputs each indicating a label, confidence factor, weight describing the inputs, an output image, or a point cloud. In some embodiments, however, outputs of the neural network model may be obtained from a hidden layers in addition to, or in place of, output(s) from the output layer(s).

In some embodiments, each layer has a discrete, recognizable function with respect to input data. For example, if n is equal to 3, a first layer analyzes the first dimension of the inputs, a second layer the second dimension, and the final layer the third dimension of the inputs. Dimensions may correspond to aspects considered strongly determinative, then those considered of intermediate importance, and finally those of less relevance.

In some embodiments, the layers may not be clearly delineated in terms of the functionality they perform. For example, two or more of hidden layers may share decisions relating to labeling, with no single layer making an independent decision as to labeling.

Based upon these analyses, the processing element may learn how to identify characteristics and patterns that may then be applied to analyzing and classifying objects. The processing element may also learn how to identify attributes of different objects in different lighting. This information may be used to determine which classification models to use and which classifications to provide.

Some embodiments involve the use of one or more electronic processing or computing devices. As used herein, the terms “processor” and “computer” and related terms, e.g., “processing device,” and “computing device” are not limited to just those integrated circuits referred to in the art as a computer, but broadly refers to a processor, a processing device or system, a general purpose central processing unit (CPU), a graphics processing unit (GPU), a microcontroller, a microcomputer, a programmable logic controller (PLC), a reduced instruction set computer (RISC) processor, a field programmable gate array (FPGA), a digital signal processor (DSP), an application specific integrated circuit (ASIC), and other programmable circuits or processing devices capable of executing the functions described herein, and these terms are used interchangeably herein. These processing devices are generally “configured” to execute functions by programming or being programmed, or by the provisioning of instructions for execution. The above examples are not intended to limit in any way the definition or meaning of the terms processor, processing device, and related terms.

The various aspects illustrated by logical blocks, modules, circuits, processes, algorithms, and algorithm steps described above may be implemented as electronic hardware, software, or combinations of both. Certain disclosed components, blocks, modules, circuits, and steps are described in terms of their functionality, illustrating the interchangeability of their implementation in electronic hardware or software. The implementation of such functionality varies among different applications given varying system architectures and design constraints. Although such implementations may vary from application to application, they do not constitute a departure from the scope of this disclosure.

Aspects of embodiments implemented in software may be implemented in program code, application software, application programming interfaces (APIs), firmware, middleware, microcode, hardware description languages (HDLs), or any combination thereof. A code segment or machine-executable instruction may represent a procedure, a function, a subprogram, a routine, a subroutine, a module, a software package, a class, or any combination of instructions, data structures, or program statements. A code segment may be coupled to, or integrated with, another code segment or an electronic hardware by passing or receiving information, data, arguments, parameters, memory contents, or memory locations. Information, arguments, parameters, data, etc. may be passed, forwarded, or transmitted via any suitable means including memory sharing, message passing, token passing, network transmission, etc.

The actual software code or specialized control hardware used to implement these systems and methods is not limiting of the claimed features or this disclosure. Thus, the operation and behavior of the systems and methods were described without reference to the specific software code being understood that software and control hardware can be designed to implement the systems and methods based on the description herein.

When implemented in software, the disclosed functions may be embodied, or stored, as one or more instructions or code on or in memory. In the embodiments described herein, memory includes non-transitory computer-readable media, which may include, but is not limited to, media such as flash memory, a random access memory (RAM), read-only memory (ROM), erasable programmable read-only memory (EPROM), electrically erasable programmable read-only memory (EEPROM), and non-volatile RAM (NVRAM). As used herein, the term “non-transitory computer-readable media” is intended to be representative of any tangible, computer-readable media, including, without limitation, non-transitory computer storage devices, including, without limitation, volatile and non-volatile media, and removable and non-removable media such as a firmware, physical and virtual storage, CD-ROM, DVD, and any other digital source such as a network, a server, cloud system, or the Internet, as well as yet to be developed digital means, with the sole exception being a transitory propagating signal. The methods described herein may be embodied as executable instructions, e.g., “software” and “firmware,” in a non-transitory computer-readable medium. As used herein, the terms “software” and “firmware” are interchangeable and include any computer program stored in memory for execution by personal computers, workstations, clients, and servers. Such instructions, when executed by a processor, configure the processor to perform at least a portion of the disclosed methods.

As used herein, an element or step recited in the singular and proceeded with the word “a” or “an” should be understood as not excluding plural elements or steps unless such exclusion is explicitly recited. Furthermore, references to “one embodiment” of the disclosure or an “exemplary” or “example” embodiment are not intended to be interpreted as excluding the existence of additional embodiments that also incorporate the recited features. Likewise, limitations associated with “one embodiment” or “an embodiment” should not be interpreted as limiting to all embodiments unless explicitly recited.

Disjunctive language such as the phrase “at least one of X, Y, or Z,” unless specifically stated otherwise, is generally intended, within the context presented, to disclose that an item, term, etc. may be either X, Y, or Z, or any combination thereof (e.g., X, Y, and/or Z). Likewise, conjunctive language such as the phrase “at least one of X, Y, and Z,” unless specifically stated otherwise, is generally intended, within the context presented, to disclose at least one of X, at least one of Y, and at least one of Z.

The disclosed systems and methods are not limited to the specific embodiments described herein. Rather, components of the systems or steps of the methods may be utilized independently and separately from other described components or steps.

This written description uses examples to disclose various embodiments, which include the best mode, to enable any person skilled in the art to practice those embodiments, including making and using any devices or systems and performing any incorporated methods. The patentable scope is defined by the claims and may include other examples that occur to those skilled in the art. Such other examples are intended to be within the scope of the claims if they have structural elements that do not differ from the literal language of the claims, or if they include equivalent structural elements with insubstantial differences from the literal language of the claims.

What is claimed is:

1. A polarimetric wavefront light detection and ranging (PolLidar) sensor, comprising:
an emitter module having an optical emitter aperture,
a receiver module having an optical receiver aperture, wherein the receiver module is separate from the emitter module; and
a mirror for scene scanning.

2. The PolLidar sensor of claim 1, wherein the mirror for scene scanning is an oscillating microelectromechanical system (MEMS) micro-mirror.

3. The PolLidar sensor of claim 1, further comprising a bandpass filter configured to operate at a wavelength of 1064 nanometer (nm) and to suppress visible ambient light.

4. The PolLidar sensor of claim 1, wherein the emitter module is configured to emit horizontally polarized laser light that is modulated using a half-wave plate (HWP) and a quarter-wave plate (QWP).

5. The PolLidar sensor of claim 4, wherein the HWP is associated with a first rotation angle and the QWP is associated with a second rotation angle.

6. The PolLidar sensor of claim 1, wherein the receiver module is configured to capture changes in polarization of light emitted by the emitter module using a quarter-wave plate (QWP), a linear polarizer (LP), and a bandpass filter.

7. The PolLidar sensor of claim 6, wherein the QWP is associated with a third rotation angle and the LP is associated with a fourth rotation angle.

8. The PolLidar sensor of claim 1, wherein the receiver module comprises an avalanche photodiode (APD) with an adjustable bias for sensitivity adjustment.

9. The PolLidar sensor of claim 8, wherein the receiver module further comprises an analog-to-digital converter (ADC) sampling at 1 giga-samples/second rate.

10. The PolLidar sensor of claim 1 having characteristics including long-range capabilities up to 223 m and high spatial resolution of 150 rows and 236 columns over a 23.95° vertical field-of-view and 31.53° horizontal field-of-view.

11. A vehicle, comprising:
at least one sensor;
at least one memory storing instructions thereon; and
at least one processor configured to execute the stored instructions to:
initiate emission of horizontally polarized laser light by the at least one sensor;
cause reception of light reflected from an object at a detector of the at least one sensor;
compute temporal polarimetric reflectance of a scene as a model that is a sum of a specular reflection and a diffuse reflection;
compute a first Mueller matrix for an emitter module of the at least one sensor;
compute a second Mueller matrix for a receiver module of the at least sensor;
generate synthetic polarimetric raw wavefronts based at least in part upon the computed first and second Mueller matrices and the computed temporal polarimetric reflectance of the scene; and
generate temporal wavefronts from the generated synthetic polarimetric raw wavefronts to model beam divergence and scene reconstruction.

12. The vehicle of claim 11, wherein the first Mueller matrix is a function of a half-wave plate (HWP) and a quarter-wave plate (QWP).

13. The vehicle of claim 11, wherein the second Mueller matrix is a function of a quarter-wave plate (QWP) and a linear polarizer (LP).

14. The vehicle of claim 11, wherein the receiver module is separate from the emitter module.

15. The vehicle of claim 14, wherein the receiver module comprises an optical receiver aperture that is separate from an optical emitter aperture of the emitter module.

16. The vehicle of claim 11, wherein the at least one sensor comprising a mirror for scene scanning, wherein the mirror for scene scanning is an oscillating microelectromechanical system (MEMS) micro-mirror.

17. The vehicle of claim 11, wherein the emitter module is configured to emit horizontally polarized laser light that is modulated using a half-wave plate (HWP) and a quarter-wave plate (QWP), and wherein the HWP is associated with a first rotation angle and the QWP is associated with a second rotation angle.

18. The vehicle of claim 11, wherein the receiver module is configured to capture changes in polarization of light emitted by the emitter module using a quarter-wave plate (QWP), a linear polarizer (LP), and a bandpass filter, and wherein the QWP is associated with a third rotation angle and the LP is associated with a fourth rotation angle.

19. The vehicle of claim 11, wherein the receiver module comprises:
an avalanche photodiode (APD) with an adjustable bias for sensitivity adjustment; and
an analog-to-digital converter (ADC) sampling at 1 giga-samples/second rate.

20. A computer-implemented method comprising:
initiating emission of horizontally polarized laser light by a polarimetric wavefront light detection and ranging (PolLidar) sensor, the PolLidar sensor comprising an emitter module having an optical emitter aperture, a receiver module having an optical receiver aperture, and a mirror, wherein the receiver module is separate from the emitter module;
causing reception of light reflected from an object at a detector of the PolLidar sensor;
computing temporal polarimetric reflectance of a scene as a model that is a sum of a specular reflection and a diffuse reflection;
computing a first Mueller matrix for the emitter module;
computing a second Mueller matrix for the receiver module;
generating synthetic polarimetric raw wavefronts based at least in part upon the computed first and second Mueller matrices and the computed temporal polarimetric reflectance of the scene; and
generating temporal wavefronts from the generated synthetic polarimetric raw wavefronts to model beam divergence and scene reconstruction.
